(19) United States
(12) Patent Application Publication
(10) Pub. No.: US 2008/0108008 A1
(43) Pub. Date: May 8, 2008

(54) Systems and methods for orthodontic treatments

(76) Inventor: Kun Sung Chung, Seoul (KR)

Correspondence Address: Patent Office of Dr. Chung S. Park, P.O. Box 62312, Sunnyvale, CA, 94088-2312, US

(21) Appl. No.: 11/594,597

(22) Filed: Nov. 8, 2006

(51) Int. Cl. A61C 3/00

(52) U.S. Cl. 433/24; 433/7; 433/18

(57) ABSTRACT

Systems and methods for moving teeth to desired positions within a patient's mouth. A method starts with a step of installing orthodontic appliances, such as brackets, on the teeth to be involved in an orthodontic treatment Then, the gingival tissue is incised along a curve that substantially extends in parallel to the gum line of the gingival tissue at a predetermined distance. Subsequently, the incised gingival tissue is reflected to form a gingival flap and thereby to expose an alveolar bone underlying the gingival flap. A portion of the exposed alveolar bone adjacent the roots of the teeth is moved, preferably in the form of a groove. Then, the orthodontic appliances are adjusted to move the teeth and thereby to realign the teeth as intended.

### FIELD OF INVENTION

The present invention relates to a method of performing dental procedures, and more particularly, to a method of performing orthodontic procedures and a device for performing some of the procedures.

### BACKGROUND OF INVENTION

A fundamental objective in orthodontics is to realign a patient's teeth to positions where the teeth function optimally and aesthetically. In general, appliances, such as brackets, are applied to the teeth of the patient. The brackets have slots for receiving an archwire. The bracket-archwire interaction governs forces applied to the teeth and defines the desired direction of tooth movement. Typically, orthodontic treatments are divided into two approaches according to the direction in which the major tooth movements are made to realign the teeth. The first approach may be referred to as expansion method. In this method, the crooked and/or crowded teeth are moved facial or peripheral side of the jaw bone to make space for them. FIG. 1 illustrates an upper arch 10 with crowded/crooked teeth 12 prior to the expansion, wherein arrows 14 show the direction of expansion. FIG. 2 illustrates the upper arch 10a with straightened teeth 12a after expansion and a suitable orthodontic treatment using the brackets. The second approach may be referred to as retraction method. In the retraction method, one or more teeth, typically first bicuspid teeth, are removed to create more space in the jaw for the teeth that remain, wherein the remaining teeth are moved in the space to be aligned as intended. FIG. 3 illustrates an upper arch 20 with crowded/crooked teeth 22 including the first bicuspid teeth 24. FIG. 4 is a schematic diagram of the upper arch 20a after extraction of the first bicuspid teeth 24. Typically, a proper orthodontic treatment using the brackets may be followed to move the remaining upper anterior teeth 26 with respect to the posterior teeth 28, thereby dosing the space 30 previously occupied by the first bicuspid teeth 24 and realigning the remaining teeth. There are other variations of these two approaches. For instance, each of the crowded teeth may be ground to provide room for them. For another instance, both approaches may be applied, i.e., the dentist may retract one or more teeth prior to the expansion of remaining teeth.

FIG. 5 is a frontal view of anterior teeth 52 and brackets respectively attached, either fixedly or removably, to the teeth. As illustrated, the teeth 52 are covered partially by gingival tissue or gum 54. FIG. 6 is a cross section view of an upper anterior tooth 52 that includes central incisor 64. A portion of the central incisor 64 near the root of the tooth 52 is surrounded by periodontal ligament 58, which in turn is covered by cortical bone or plate 60. The gingival tissue 54 also covers the outer surface of the cortical bone 60. The root of the tooth 52 is surrounded by medullary bone 62 that supplies blood to the tooth 52. The term alveolar bone collectively refers to a portion of the medullary bone 62 and the cortical bone 60. The alveolar bone remodels around the tooth 52 being moved in response to pressure from one side of the tooth 52.

One of the typical orthodontic treatments is disclosed the U.S. Pat. No. 6,109,916 to Wilcko and illustrated in FIGS. 7-10. As illustrated in FIG. 7, a set of brackets 74 are attached to crooked/crowded anterior teeth 72. The dotted lines represent portions of the teeth 72 surrounded by the cortical bone 80. In the Wilcko '916 patent, surgery is performed under intravenous sedation approximately two to seven days following activation of the brackets 74. The surgery begins with the step of reflecting the gingival tissue or gum 76. The gingival tissue 76 is reflected both facially and lingually around all of the teeth 72 in the dental arch by intracrevicular incision, which is an incision in the space between the teeth 72 and the gum 76. The resulting full thickness gingival flaps, referred to as full thickness mucoperiosteal flaps, 76 and 82 are shown in FIG. 8.

After the flaps 76 and 82 have been reflected, the exposed cortical bone or plate 80 adjacent each of the teeth 72 to be moved is partially decorticated. FIG. 9 shows that decortication takes place through the use of grooves 84 shown in the exposed facial cortical bone 80 between the roots of the teeth 72. If there is sufficient thickness of bone, perforations 86 are also made in the cortical bone 80 overlying the roots of the teeth 72 as illustrated in FIG. 9. The grooves 84 and perforations 86 extend slightly into the underlying medullar bone 81. A grafting material may be overlaid on the cortical bone 80 (nor shown in FIG. 9) and thence the flapped gum 76, 82 are sutured as shown in FIG. 10. The use of either or both of groove and perforations may cause bleeding points from the cortical bone 80 and medullary bone 83 to create capillary pathways through which pluripotential cells migrate into an overlaying grating material, and thereby to trigger the regional accelerated phenomenon.

One of the difficulties of the Wilcko's method is that the flapped gum 76 and 82 may not be replaced in their original positions after orthodontic treatment As depicted in FIG. 10, the gum line 90 recedes from its original location 92 formed on the teeth 72, i.e., gum recession may take place upon completion of the surgery and orthodontic treatment. Hereinafter, the term gum line refers to a curve at the boundary between the gingival tissue and teeth. Another difficulty may be that the curved groove 84 is not suitable for patients who do not have sufficient alveolar bone thickness. As such, there is a strong need for alternative methods and systems for repositioning teeth without gum recession and applicable for a wide range of the alveolar bone thickness.

### SUMMARY OF INVENTION

In one aspect of the invention, a method for moving teeth to desired positions within a patient's mouth includes steps of: installing orthodontic appliances on the teeth to be involved in an orthodontic treatment; incising gingival tissue along a curve that substantially extends in parallel to the gum line of the gingival tissue at a predetermined distance; reflecting the incised gingival tissue to form at least one gingival flap and thereby to expose an alveolar bone underlying the gingival tissue; partially decorticating the exposed alveolar bone adjacent the roots of the teeth to be moved; and adjusting the orthodontic appliances to move the teeth and thereby to realign the teeth as intended.

In another aspect of the invention, a retraction device for applying orthodontic forces between anterior teeth and posterior teeth that separated from the anterior teeth by at least one edentulous area in the dental arch of a patient, each of the anterior and posterior teeth having a bracket installed thereon and coupled to an archwire via the bracket, includes: an anchoring device secured to an alveolar bone of the patient; at least one hooking mechanism forming a branch of the archwire and located between two neighboring ones of the anterior teeth; and a retraction unit for coupling the anchoring device to the hooking mechanism and for applying a force therebetween. The force is directed to move the anterior teeth toward the posterior teeth across the edentulous area.

In still another aspect of the invention, a retraction device for applying orthodontic forces between anterior teeth and posterior teeth that separated from the anterior teeth by at least one edentulous area in the dental arch of a patient, each of the anterior and posterior teeth having a bracket installed thereon and coupled to an archwire via the bracket, includes: an anchoring device secured to a palatal bone of the patient; at least one arm for securing at least one of the posterior teeth to the anchoring device, the arm including a first hooking mechanism; at least one second hooking mechanism forming a branch of the archwire and located between two neighboring ones of the anterior teeth; and a retraction unit for coupling the first hooking mechanism to the second hooking mechanism and for applying a force therebetween. The force is directed to move the anterior teeth toward the posterior teeth across the edentulous area.

### BRIEF DESCRIPTION OF DRAWINGS

These and other features of the invention will now be described with reference to the drawings summarized below. These drawings and the associated description are provided to illustrate preferred embodiments of the invention and are not intended to limit the scope of the invention.

FIG. 1 is a schematic diagram of an upper dental arch having overlapped and crowded teeth.

FIG. 2 is a schematic diagram of the upper dental arch in FIG. 1 after realignment.

FIG. 3 is a schematic diagram of an upper dental arch having overlapped and crowded teeth.

FIG. 4 is a schematic diagram of the upper dental arch in FIG. 3 after extraction of the first bicuspid.

FIG. 5 is a schematic diagram of upper anterior teeth after bracketing.

FIG. 6 is a cross sectional diagram of an upper anterior tooth after bracketing.

FIG. 7 shows upper anterior teeth with full thickness gingival flaps reflected by use of an existing technique.

FIG. 8 is a cross sectional diagram of an upper anterior tooth with full thickness gingival flaps reflected by use of the existing technique.

FIG. 9 shows upper anterior teeth with full thickness gingival flaps reflected and the exposed cortical plate partially decorticated by use of the existing technique.

FIG. 10 shows upper anterior teeth with gingival flaps sutured by use of the existing technique, illustrating gingival tissue recession from the original gum line.

FIG. 11 shows upper anterior teeth with gingival flaps reflected in accordance with one embodiment of the present invention.

FIG. 12 is a cross sectional diagram of an upper anterior tooth taken along the direction 12-12 in FIG. 11.

FIG. 13 is a partial side view of a dental arch, illustrating an edentulous area where the alveolar bone is partially removed after extraction of the first bicuspid in accordance with another embodiment of the present invention.

FIG. 14 is a cross sectional diagram of the edentulous area depicted in FIG. 13.

FIG. 15 is a cross sectional diagram of the edentulous area depicted in FIG. 13, illustrating a plug used for preventing the gingival tissue from collapsing and for controlling bleeding problem due to the removal of buccal and lingual plates.

FIG. 16 is an upper dental arch with edentulous areas and a pair of retraction devices in accordance with still another embodiment of the present invention.

FIG. 17 is a partial buccal or facial side view of the upper dental arch in FIG. 16, illustrating the pair of retraction devices for moving the anterior teeth toward the posterior teeth.

FIG. 18 is a schematic diagram of the retraction unit depicted in FIG. 17.

FIG. 19 is an upper dental arch with edentulous areas and a pair of retraction devices in accordance with yet another embodiment of the present invention.

FIG. 20 is a partial lingual side view of the upper dental arch in FIG. 19, illustrating the pair of retraction devices for moving the anterior teeth toward the posterior teeth.

FIG. 21 is an upper dental arch with edentulous areas and an anchoring device in accordance with further another embodiment of the present invention.

FIGS. 22 and 23 are enlarged views of portions of the retraction device depicted in FIG. 21.

### DETAILED DESCRIPTION OF EXEMPLARY EMBODIMENTS

Although this invention will be described in terms of certain preferred embodiments, other embodiments that are apparent to those of ordinary skill in the art, including embodiments that do not provide all of the benefits and features set forth herein, are also within the scope of this invention. Accordingly, the scope of the invention is defined only by reference to the appended claims.

Now referring to FIG. 11, FIG. 11 shows upper anterior teeth 102 with gingival flaps 104 reflected in accordance with one embodiment of the present invention. As depicted, brackets 106 are installed to realign the crowded anterior teeth 102. The brackets 106, or other suitable types of orthodontic appliances, may be installed on the teeth 102 to be moved to exert force on the teeth 102 toward the desired positions. The brackets 106 may be installed at anytime prior to the surgery or subsequent to it as desired by the dentists performing the surgical and orthodontic procedures.

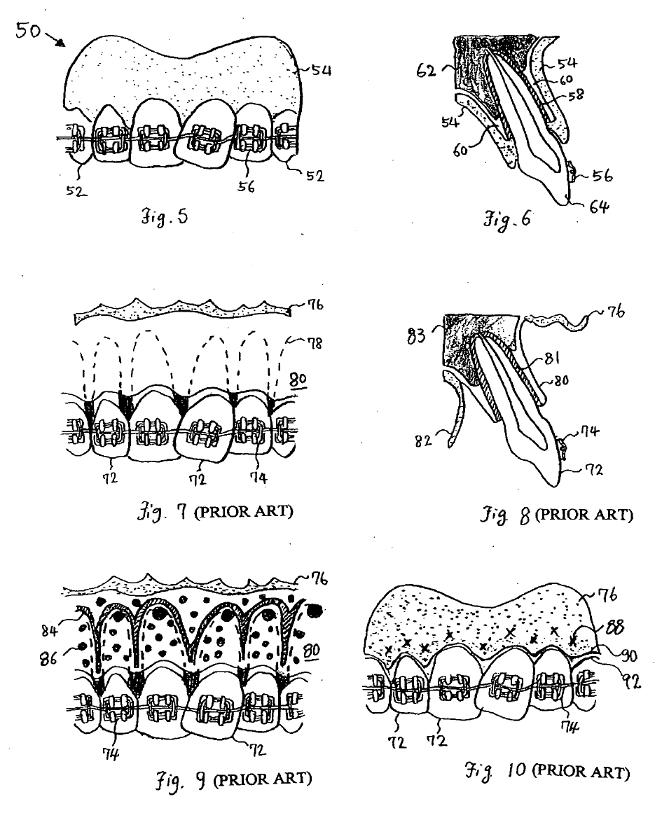

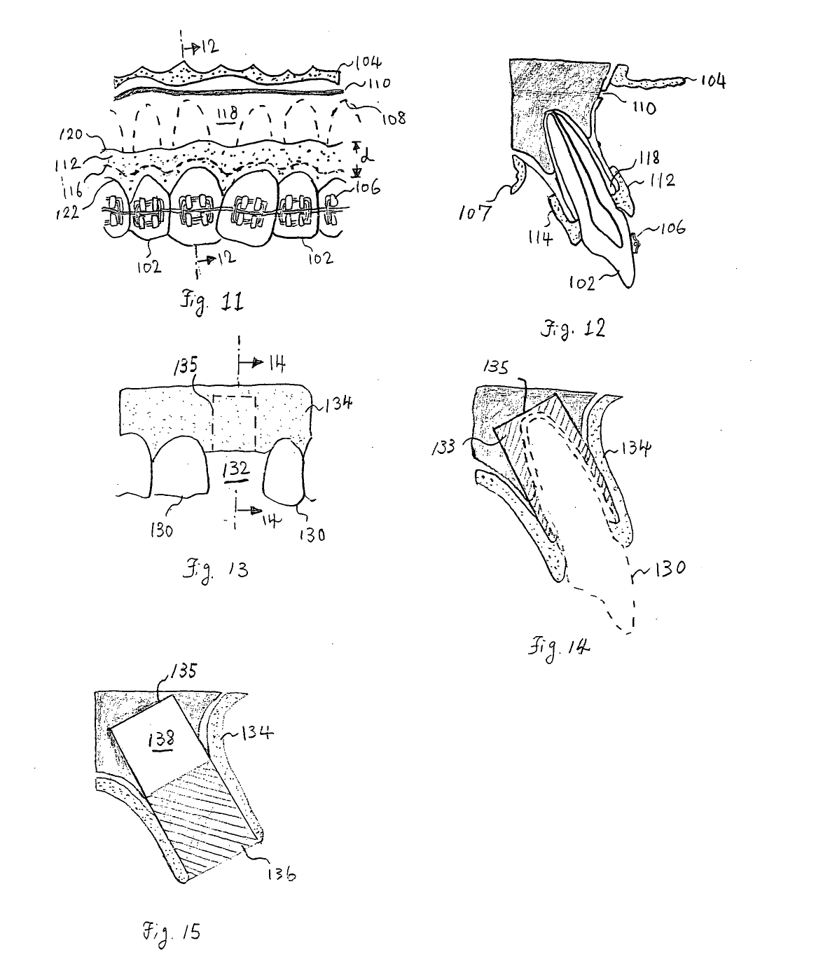

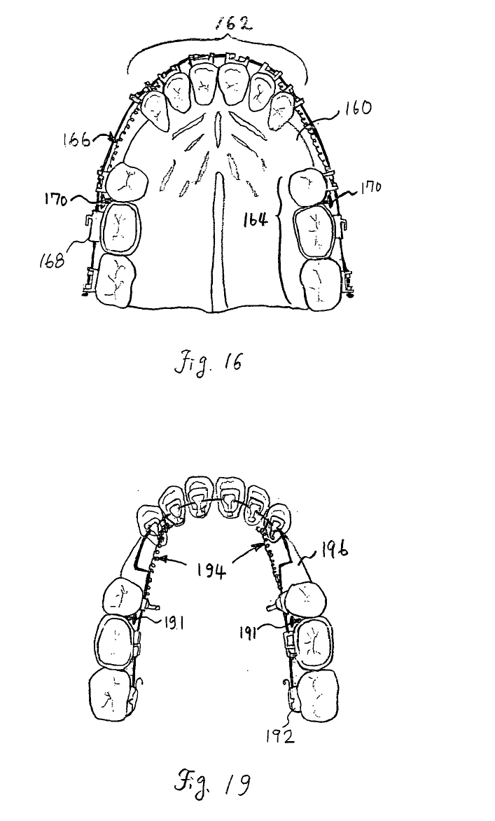

As discussed above, in the existing approach, the gingival tissue is separated from the teeth along the gum line 92 (FIG. 10), which yields a recession of the gingival tissue from the gum line upon completion of the orthodontic treatment. In contrast to the existing approach, a portion of gingival tissue 112 is separated from the cortical bone or plate 118 (FIG. 12) along a curve 120, forming a gingival flap 104. The curve 120 may extend substantially in parallel to the gum line 92 and be approximately separated from a gum line 122 by a distance d, wherein the distance d may range from 4 to 6 mm. Upon completion of the orthodontic treatment, the flap 104 is sutured (not shown in FIG. 11) and thereby the original um line is maintained, i.e., the gum line does not recede from its original location.

A cortical bone line 116 represents the boundary of the cortical bone or plate 118 on the tip side of the tooth 102, wherein the distance d is determined such that the cortical bone line 116 is interposed between the curve 120 and the gum line 122. When the flap 104 is generated to expose a portion of the cortical bone 118, the exposed portion may be decorticated (not shown in FIG. 11) in the 25 similar manner as depicted in FIG. 9, i.e., perforations and/or vertiavscalloped horizontal grooves may be formed to activate the cortical bone 118. Alternatively, a groove 110 may be formed on the cortical bone 118 (or, alveolar bone) beyond the apices 108 of the teeth 102. The depth of the groove 110 may be determined to barely extend into the medullary bone under the cortical bone 118 so that nerve tissues, such as anterior loop of the inferior alveolar nerve, is not damaged by the decortication. The perforations and/or groove(s) are formed to access vasculature and pluripotential cells in the medullary bone. It is noted that, for simplicity, only the facial side of the gingival tissue is shown. However, it should be apparent to those of ordinary skill that the same treatment can be applied to the lingual side gingival tissue 114 (FIG. 12) to form another gingival flap 106.

FIG. 12 is a cross sectional diagram of an upper anterior tooth taken along the direction 12-12 in FIG. 11. As depicted, portions of the gingival tissue 104 and 106 on the facial and lingual sides, respectively, are separated from the cortical bone 118 and reflected to gain access to the bone around the teeth to be moved. The reflected gingival tissue may form flaps 104 and 106. The bracket 106 may be installed on the either labial (or facial) or lingual side of the tooth 102, which should be apparent to those of ordinary skill. Upon completion of the decortication (perforations and/or groove(s)), the flaps 104 and 106 may be sutured to their original locations. As the portion of the gingival tissue near the original gum line 122 is not separated from the tooth 112 (FIG. 11) in the present invention, the final gum line remains the same as the original gum line, i.e., the gum line does not recede toward the root of the tooth 102 due to the surgery for the decortation process.

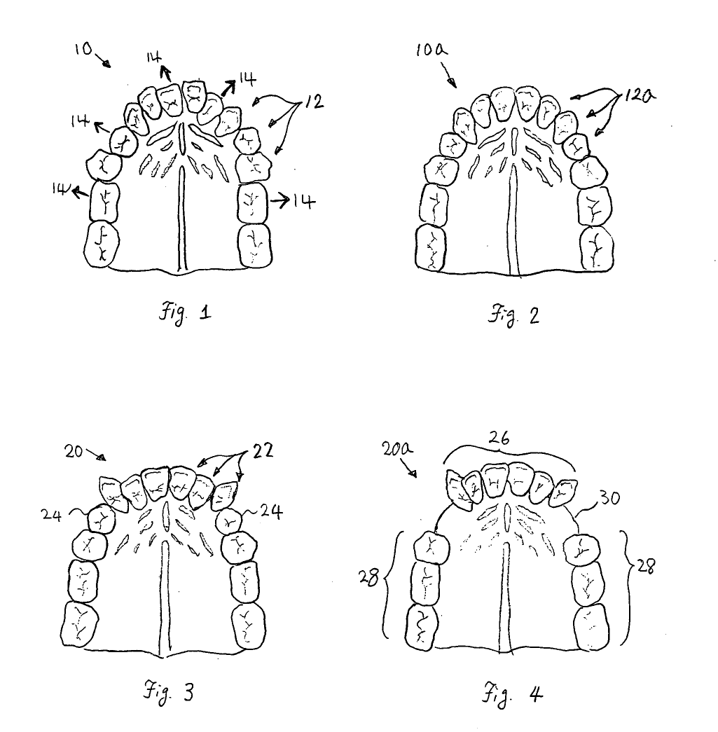

As discussed in connection with FIG. 4, one or more bicuspids may be extracted to provide spaces to the remaining teeth. FIG. 13 is a partial side view of a dental arch, illustrating an edentulous area 132. As illustrated, the alveolar bone (which collectively refers to buccal and lingual plates or bones surrounding the teeth 130) adjacent the edentulous area 132 is partially removed after extraction of the first bicuspid in accordance with another embodiment of the present invention. FIG. 14 is a cross sectional diagram of the edentulous area 132 depicted in FIG. 13. As depicted, a portion 133 of the alveolar bone, which includes buccal (or, equivalently, facial) and lingual plates or bones, is removed to form a socket 135. The removal of the portion 133 may decrease bony resistance during the subsequent orthodontic treatment, i.e., the realignment of the remaining teeth, and thereby facilitate orthodontic movement.

FIG. 15 is a cross sectional diagram of the edentulous area 132 depicted in FIG. 13, wherein a plug 136 is used for preventing the gingival tissue 134 from collapsing after extraction of the first bicuspid and for controlling bleeding due to the removal of the portion 133 of the alveolar bone (or, equivalently, buccal and lingual plates). The blood supplied into the space 138 via the medullary bone may carry cells that lead to new bone formation in the space 138, while the plug 136 may be resolved gradually during realignment of the remaining teeth so as to obviate any resistance against the intended movement of the remaining teeth.

The plug 136 may be formed of collagen material, such as Collaplug®, manufactured by Integra LifeScience Corporation, Plainsboro, N.J. The remaining teeth 130 (FIG. 13) may be rearranged by use of any suitable devices, such as brackets. As such, detailed description of the orthodontic treatment for realigning the remaining teeth is not given in the present document.

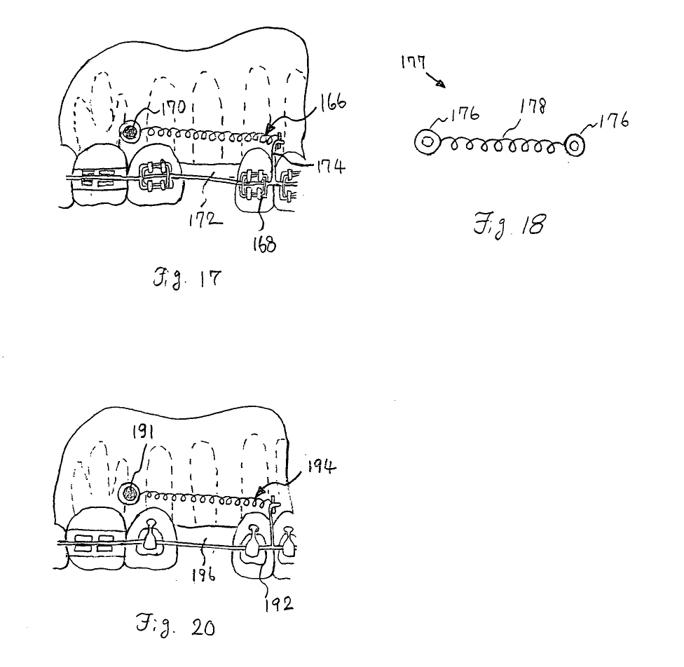

FIG. 16 is an upper dental arch with edentulous areas 160 and a pair of retraction devices 166 in accordance with another embodiment of the present invention. The alveolar bones adjacent the edentulous areas 160 may be removed by use of the technique described with reference to FIGS. 13-14, and each edentulous area 160 may be covered by a plug as depicted in FIG. 15. In FIG. 16, brackets 168 are installed on anterior teeth 162 and posterior teeth 164 to realign them. To move the anterior teeth 162 toward the posterior teeth 164, a pair of retraction devices 166 may be used. FIG. 17 is a partial buccal or facial side view of the upper dental arch in FIG. 16, illustrating the retraction device 166. FIG. 18 is a schematic diagram of a retraction unit 177 included in the retraction device in FIG. 17. As depicted, the retraction device 166 may include: an orthodontic microimplant screw 170, such as micro-screw manufactured by Dentaurum, Inc, Newton, Pa., installed in the alveolar bone through the gingival tissue and operating as an anchorage device; a pair of rings 176; and an elastic member, such as coil spring, 178 having two ends attached to the pair of rings 176; and a hooking mechanism 174 branched from the archwire 172. As depicted in FIG. 18, the retractive unit 177 includes the pair of rings 176 and elastic member 178. The length of the elastic member 178 may be determined to provide a predetermined retractive force between the ring members 176 during orthodontic treatment. It is noted that, in many retraction cases, the remaining teeth may be expanded as well. But, for simplicity, the detailed description of orthodontic realignment process of the remaining teeth 162 and 164 are not given in the present document.

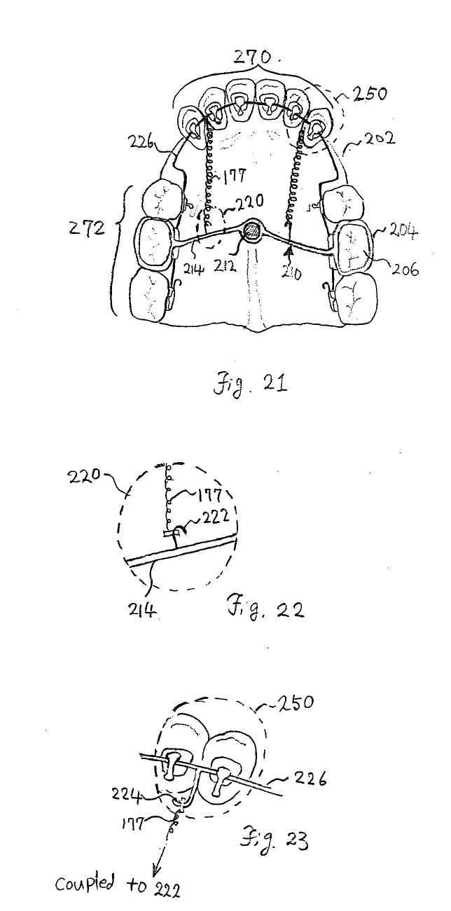

FIG. 19 is an upper dental arch with edentulous areas 196 and a pair of retraction devices 194 in accordance with still another embodiment of the present invention. As depicted, the brackets 192 and the pair of retraction devices 194 are installed on the lingual side. FIG. 20 is a partial lingual side view of the upper dental arch in FIG. 19, illustrating the pair of retraction devices 194 for moving the anterior teeth toward the posterior teeth. The structure and functions of the devices 194 are similar to those of the device 166 in FIG. 17. For instance, a microimplant screw 191 may be used as an anchoring device. It is noted that the alveolar bones adjacent the edentulous areas 196 may be removed and each edentulous area may be covered by a plug as described in connection with FIGS. 13-15.

FIG. 21 is an upper dental arch with edentulous areas 202 and a retraction device 210 in accordance with further another embodiment of the present invention. The retraction device 210 may include: a orthodontic microimplant screw 212 mounted on a palatal bone (not shown in FIG. 21) and operating as an anchoring device; and a pair of arms 214 for connecting the screw 212 to the brackets 204 installed on the first molars 206, each arm containing a hooking mechanism 222 (FIG. 22); a pair of retraction unit 177 (FIG. 18) coupled to hooking mechanisms 222 and a branch 224 (FIG. 23) of the archwire 226. The alveolar bone adjacent the edentulous areas 202 may be removed and a plug may be used for each edentulous area 202 as illustrated in connection with FIGS. 13-15.

FIGS. 22 and 23 are respectively enlarged views of portions 220 and 250 in FIG. 21. As depicted in FIG. 22, each arm 214 may include a hooking mechanism 222 that are coupled to the retraction unit 177. Likewise, the branch 224 of the archwire 226 may be coupled to the retraction unit 177 as depicted in FIG. 23. It is noted that several variations of the hooking mechanism can be used without deviation from the spirit of the present invention. For example, an elastic member may be used in place of the retraction unit 177.

Those skilled in the art will appreciate that the methods and designs described above have additional applications and that the relevant applications are not limited to those specifically recited above. Also, the present invention may be embodied in other specific forms without departing from the essential characteristics as described herein. The embodiments described above are to be considered in all respects as illustrative only and not restrictive in any manner.

1. A method for moving teeth to desired positions within a patient's mouth, comprising:
installing orthodontic appliances on the teeth to be involved in an orthodontic treatment;
incising gingival tissue along a curve that extends substantially in parallel to the gum line of the gingival tissue at a predetermined distance;
reflecting the incised gingival tissue to form at least one gingival flap and thereby to expose an alveolar bone underlying the gingival tissue, wherein a portion of the gingival tissue between the curve and the gum line remains attached to the teeth;
partially decorticating the exposed alveolar bone adjacent the roots of the teeth to be moved; and
adjusting the orthodontic appliances to move the teeth and thereby to realign the teeth as intended.

2. A method for moving teeth to desired positions within a patient's mouth as recited in claim 1, further comprising:
replacing the reflected gingival flap essentially to its original position.

3. A method for moving teeth to desired positions within a patient's mouth as recited in claim 2, wherein said step of installing orthodontic appliances takes place after the step of replacing the reflected gingival flaps.

4. A method for moving teeth to desired positions within a patient's mouth as recited in claim 1, wherein said step of partially decorticating alveolar bone includes:
forming a groove on the alveolar bone.

5. A method for moving teeth to desired positions within a patient's mouth as recited in claim 1, wherein said step of installing orthodontic appliances takes place before the step of incising the gingival tissue.

6. A method for moving teeth to desired positions within a patient's mouth as recited in claim 1, wherein said step of installing orthodontic appliances takes place after the step of partially decorticating the alveolar bone.

7. A method for moving teeth to desired positions within a patient's mouth as recited in claim 1, further comprising:
extracting at least one of the teeth to form an edentulous area and thereby to provide spaces to the rest of the teeth;
removing portions of buccal and lingual plates adjacent the edentulous area and thereby forming a socket; and
placing a plug in the edentulous area to prevent the gingival tissue from collapsing and to control bleeding from the socket.

8. A method for moving teeth to desired positions within a patient's mouth as recited in claim 7, wherein the plug is made of a material that resolves gradually during a preset time interval.

9. A method for moving teeth to desired positions within a patient's mouth, as recited in claim 8, wherein further comprising, prior to the step of adjusting the orthodontic appliances:
installing a retraction device to exert an orthodontic force to the teeth.

10-19. (canceled)

20. A method for moving teeth to desired positions within a patient's mouth as recited in claim 1, wherein, in the step of incising gingival tissue, the predetermined distance is determined such that a cortical bone line is interposed between the gum line and the curve.

21. A method for moving teeth to desired positions within a patient's mouth as recited in claim 1, wherein the predetermined distance is 4 mm-6 mm.
